(19) United States
(12) Patent Application Publication
(10) Pub. No.: US 2024/0343494 A1
(43) Pub. Date: Oct. 17, 2024

(54) STRIP BELT FOR A MERGE CONVEYOR

(71) Applicant: Motion Industries, Inc., Birmingham, AL (US)

(72) Inventor: Seth Howard Stoner, Bel Air, MD (US)

(21) Appl. No.: 18/133,027

(22) Filed: Apr. 11, 2023

(51) Int. Cl. B65G 15/34; B65G 15/46; B65G 47/68

(52) U.S. Cl. CPC B65G 15/34; B65G 15/46; B65G 47/681

(57) ABSTRACT

A conveyor belt includes a belt body defining an outer belt surface and an inner belt surface opposite the outer belt surface; a belt guide extending outward from the inner belt surface of the belt body and monolithically formed with the belt body; and a plurality of longitudinal reinforcement cords imbedded within the belt body.

### TECHNICAL FIELD

This disclosure relates to conveyance systems. More specifically, this disclosure relates to a merge conveyor for a conveyor system.

### BACKGROUND

Merge conveyors of conveyor systems are typically used to transfer items onto a primary conveyor. Merge conveyors often comprise one or more strip belts. However, various weak points can reduce the lifespan of the strip belts. Failure points include the splice points of mechanically-spliced strip belts and the attachment point of a belt guide to the strip belt. Additionally, stretching of the strip belt can cause result in failure.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a conveyor belt comprising a belt body defining an outer belt surface and an inner belt surface opposite the outer belt surface; a belt guide extending outward from the inner belt surface of the belt body and monolithically formed with the belt body; and a plurality of longitudinal reinforcement cords imbedded within the belt body.

Also disclosed is a conveyor system comprising a pulley system comprising a rotating pulley, the rotating pulley defining an annular guide groove extending about a circumference of the rotating pulley; and a conveyor belt configured to slide along the rotating pulley, the conveyor belt comprising a belt body and a belt guide, the belt body defining an outer belt surface and an inner belt surface opposite the outer belt surface, the belt guide extending outward from the inner belt surface of the belt body and monolithically formed with the belt body; wherein the belt guide of the conveyor belt engages the annular guide groove of the rotating pulley to align the conveyor belt on the rotating pulley and to guide the conveyor belt about the pulley system.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of a conveyor system in accordance with one aspect of the present disclosure.

FIG. 2 is a perspective view of the conveyor system according to another aspect of the present disclosure.

FIG. 3 is another perspective view of the conveyor system of FIG. 2.

FIG. 4 is an end perspective view of a merge conveyor of the conveyor system of FIG. 2.

FIG. 5 is a cross-sectional bottom perspective view of a split belt of the merge conveyor taken along line 5-5 in FIG. 3, in accordance with another example aspect of the present disclosure.

FIG. 6 is a cross-sectional bottom perspective view of the split belt taken along line 5-5 in FIG. 3, in accordance with another aspect of the present disclosure.

FIG. 7 is a cross-sectional end view of the split belt of FIG. 6 taken along line 5-5 in FIG. 3.

FIG. 8 is a cross-sectional top perspective view of the split belt taken along line 5-5 in FIG. 3, in accordance with another aspect of the present disclosure.

FIG. 9 is a cross-sectional end view of the split belt taken along line 5-5 in FIG. 3, in accordance with another aspect of the present disclosure.

FIG. 10 is a detailed side view of the split belt, in accordance with another aspect of the present disclosure.

FIG. 11 is a cross-sectional view of the split belt engaging a pulley system in accordance with another example aspect of the present disclosure, taken along line 5-5 in FIG. 3.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a conveyor belt and associated methods, systems, devices, and various apparatus. Example aspects of the conveyor belt can comprise a belt body and a belt guide monolithically formed with the belt body. It would be understood by one of skill in the art that the conveyor belt is described in but a few exemplary embodiments among many. No particular terminology or description should be considered limiting on the disclosure or the scope of any claims issuing therefrom.

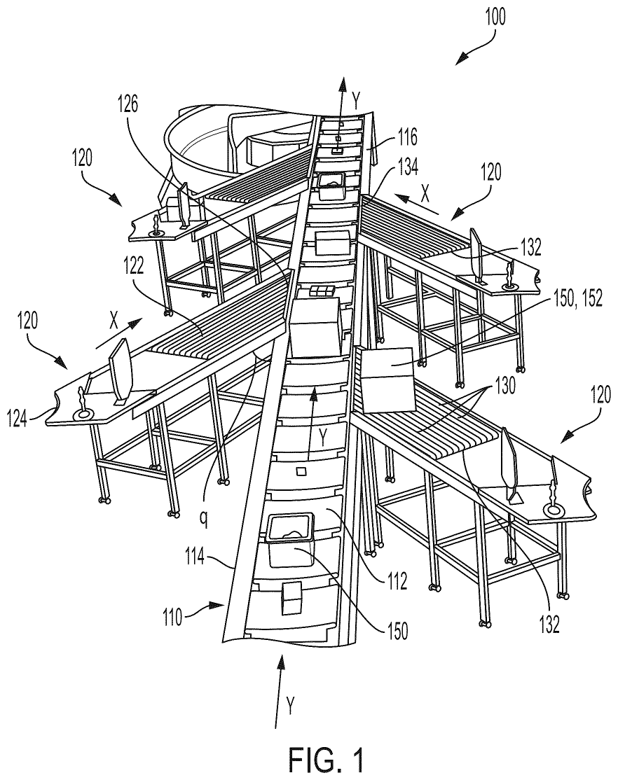

FIG. 1 is a perspective view of a conveyor system 100, in accordance with one aspect of the present disclosure. Example aspects of the conveyor system 100 can comprise an elongated primary conveyor 110 and one or more merge conveyors 120 each merging with the primary conveyor 110. The primary conveyor 110 can be substantially linear in the present aspect, however, in other aspects the primary conveyor 110 can comprise curved or angled sections. The primary conveyor 110 can be configured to convey items 150 along the conveyor system 100 from a first location to a second location. The items 150 can be, for example and without limitation, packaging boxes 152 or any other suitable item to be conveyed. The primary conveyor 110 can comprise a primary conveyor belt 112, which can be a roller bed conveyor belt, a flat belt conveyor belt, or any other suitable type of conveyor belt known in the art. The primary conveyor 110 can define a first primary conveyor side 114 and an opposite second primary conveyor side 116, and each of the merge conveyors 120 can be configured to feed items 150 onto the primary conveyor 110 at either the first primary conveyor side 114 or the second primary conveyor side 116. Items 150 disposed on each merge conveyor 120 can be conveyed towards and transferred onto the primary conveyor 110 in a merge direction X, and the items 150 transferred onto the primary conveyor 110 can be conveyed there-along in a primary direction Y.

In example aspects, each of the merge conveyors 120 can be oriented at an acute angle θ relative to the primary conveyor 110. In other aspects, any or all of the merge conveyors 120 can be oriented about perpendicular or at an obtuse angle relative to the primary conveyor 110. Each merge conveyor 120 can define a first merge conveyor end 124 and a second merge conveyor end 126 opposite the first merge conveyor end 124. The second merge conveyor end 126 of each merge conveyor 120 can be disposed at or adjacent to either the first primary conveyor side 114 or the second primary conveyor side 116 of the primary conveyor 110. In some aspects, the merge conveyor 120 can be affixed to the primary conveyor 110 at the second merge conveyor end 126; however, in other aspects, the merge conveyor 120 may not be affixed to the primary conveyor 110. According to example aspects, each merge conveyor 120 can comprise one or more merge conveyor belts 122. In the present aspect, the one or more merge conveyor belts 122 can comprise a plurality of strip conveyor belts 130, or “strip belts” 130. Each of the strip belts 130 can be a roller bed conveyor belt, a flat belt conveyor belt, or any other suitable type of conveyor belt known in the art. The strip belts 130 of each merge conveyor 120 can be arranged laterally side by side and parallel to one another, as illustrated. Each of the strip belts 130 can define a proximal belt end 132 and a distal belt end 134. The proximal belt end 132 of each strip belt 130 can be disposed at or adjacent to the second merge conveyor end 126 of the merge conveyor 120.

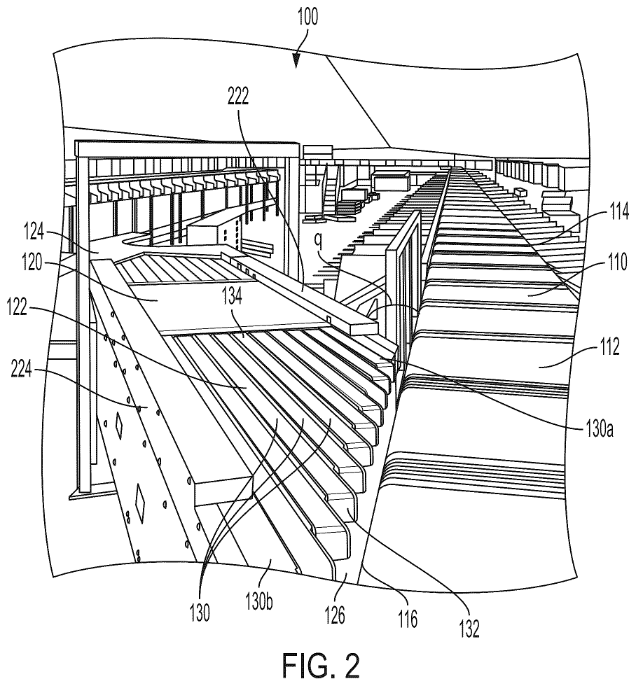

FIG. 2 illustrates one of the merge conveyors 120 merging with the primary conveyor 110. The merge conveyor 120 comprises a plurality of the strip belts 130. The proximal belt end 132 of each strip belt 130 can be disposed adjacent to the second primary conveyor side 116 of the primary conveyor 110, so that the merge conveyor 120 can feed items 150 (shown in FIG. 1) onto the primary conveyor 110 at the second primary conveyor side 116. As shown, the merge conveyor 120 can be oriented at the acute angle θ relative to the primary conveyor 110. The acute angle θ can be defined between an inner merge conveyor side 222 of the merge conveyor 120 and the second primary conveyor side 116 of the primary conveyor 110. The inner merge conveyor side 222 can be disposed opposite an outer merge conveyor side 224 of the merge conveyor 120. Because of the acute angle θ between the merge conveyor 120 and the primary conveyor 110, the second merge conveyor end 126 can be angled relative to the inner and outer merge conveyor sides 222, 224. As such, the proximal belt ends 132 of the strip belts 130 disposed at or adjacent to the second merge conveyor end 126 may not be laterally aligned in some aspects. For example, in the present aspect, the proximal belt end 132 of each strip belt 130 can be longitudinally offset from the proximal belt ends 132 of adjacent strip belts 130, such that each of the proximal belt ends 132 can be oriented about proximate to the primary conveyor belt 112.

Moreover, in some example aspects, the distal belt ends 134 of the strip belts 130 can be substantially laterally aligned with one another, as shown. Because the distal belt ends 134 of the strip belts 130 can be laterally aligned but the proximal belt ends 132 of the strip belts 130 can be longitudinally offset from one another, the strip belts 130 can thereby define varying lengths. In the present aspect, the strip belts 130 can incrementally increase in length from the inner merge conveyor side 222 to the outer merge conveyor side 224. That is, an innermost strip belt 130a of the strip belts 130 disposed at the inner merge conveyor side 222 can define the shortest length, and an outermost strip belt 130b of the strip belts 130 disposed at the outer merge conveyor side 224 can define the longest length.

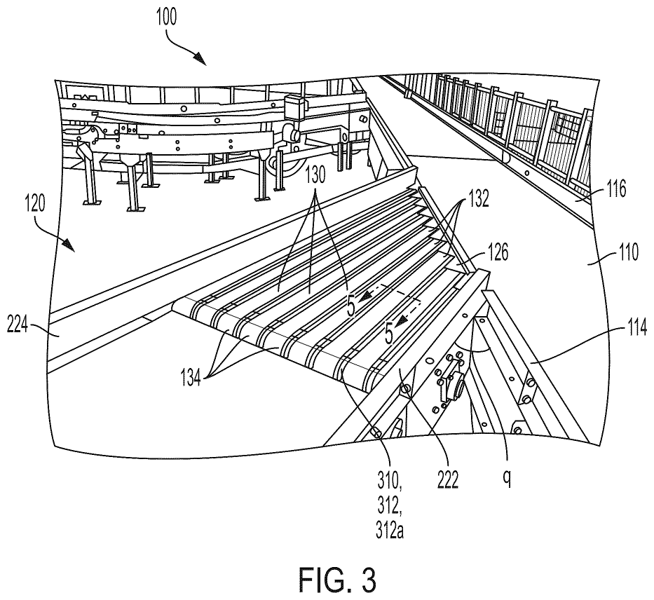

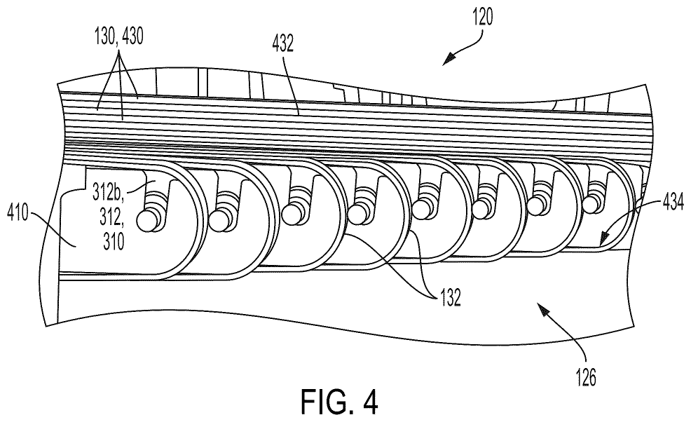

FIG. 3 further illustrates the lateral alignment of the distal belt ends 134 of the strip belts 130 of a corresponding merge conveyor 120. In other aspects, however, some or all of the proximal belt ends 132 of the strip belts 130 may be substantially laterally aligned and/or some or all of the distal belt ends 134 of the strip belts 130 may not be laterally aligned. Furthermore, in other aspects, the lengths of some or all of the strip belts 130 may be substantially equal. According to example aspects, each of the strip belts 130 can be driven and guided by a drive system, which can be a pulley system 310 in the present aspect. The drive system (e.g., the pulley system 310) can comprise one or more guides, which can include a plurality of rotating pulleys 312 in the present aspect. For example, the pulley system 310 can comprise at least a first one of the pulleys 312 (i.e., a head pulley 312a) disposed at the distal belt end 134 of each strip belt 130 and a second one of the pulleys 312 (i.e., a tail pulley 312b, shown in FIG. 4) disposed at the proximal belt end 132 of each strip belt 130.

Some or all of the rotating pulleys, including the head and tail pulleys 312a,b, can be configured to guide the corresponding strip belt 130 as it slides around the pulley system 310. As shown, the distal belt end 134 of each strip belt 130 can wrap around the corresponding head pulley 312a. In example aspects, the head pulley 312a can be a driven pulley configured to both drive the movement of the strip belt 130. The driven head pulley 312a can be rotationally driven by a motor, for example, and the rotation of the head pulley 312a can impart motion to the strip belt 130. The head pulley 312a can further be configured to guide the strip belt 130 about the pulley system 310.

FIG. 4 illustrates a side view of the second merge conveyor end 126 of one of the merge conveyors 120. The proximal belt ends 132 of the strip belts 130 can be longitudinally offset from one another, as shown. According to example aspects, each of the strip belts 130 can be configured to slide across a steel bed 410. In example aspects, some or all of the pulleys 312, can be configured to nest within the steel bed 410. The proximal belt end 132 of each strip belt 130 can wrap around the corresponding tail pulley 312b, and the tail pulley 312b can be an idler pulley configured to guide the strip belt 130 about the pulley system 310. In some aspects, additional guides or pulleys 312 of the pulley system 310 can further guide the strip belt 130 about the pulley system 310. Moreover, in some aspects, pulley system 310 may comprise a take-up pulley configured to tension the strip belt 130 and/or a take-up indicator for indicating the current tension of the strip belt 130, as the tension may increase or decrease beyond the desired tension in various circumstances.

According to example aspects, each of the strip belts 130 can be formed as an endless strip belt 430 and can snake around the pulley system 310 in a continuous loop. For example, in some aspects, each of the strip belts 130 can be formed as an endless strip belt 430 by splicing opposing free ends of the strip belt 130 together via thermoplastic finger splicing (i.e., melting fingers at the opposing free ends together to re-bond the material of the strip belt 130). In other aspects, the opposing free ends of the strip belt 130 can be connected together by any other suitable type of endless splice or connection technique for forming an endless conveyor belt. Endless conveyor belts, such as the endless strip belts 430 described herein, can be advantageous over mechanically-spliced conveyor belts by reducing the likelihood of failure at the splice point. Mechanical splicing, which can include belt lacing for example and without limitation, can be prone to failure and can therefore reduce the lifespan of mechanically-spliced conveyor belts.

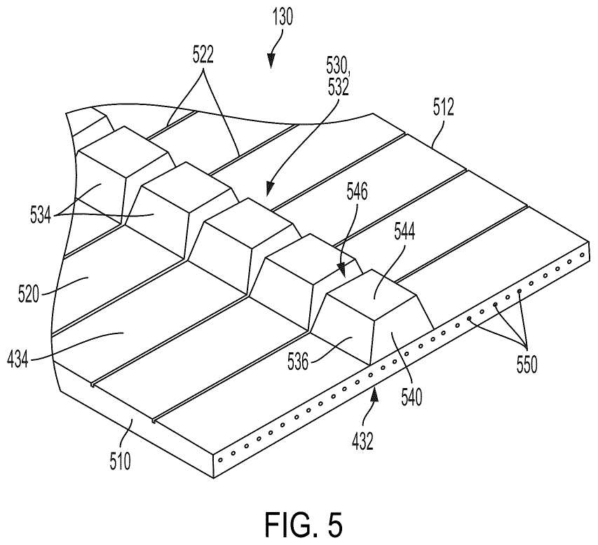

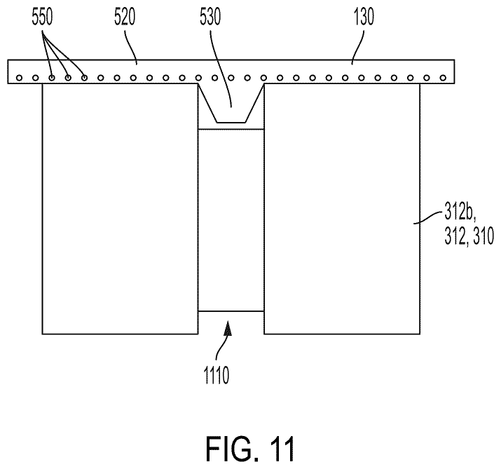

Each of the strip belts 130 can define an outer belt surface 432 and an opposite inner belt surface 434, as shown. The outer belt surface 432 can face away from the pulley system 310 and the items 150 (shown in FIG. 1) can be placed on the outer belt surface 432 for conveyance along the merge conveyor 120. In some example aspects, the outer belt surface 432 can be textured to improve the grip of the outer belt surface 432 on the items 150 received on the strip belt 130, as described in further detail below. The inner belt surface 434 can be configured to contact and slide on the various pulleys 312 of the pulley system 310, the steel bed 410, and/or other internal components of the merge conveyor 120. In example aspects, a belt guide 530 (shown in FIG. 5) extending from the inner belt surface 434 can engage a guide groove 1110 (shown in FIG. 11) formed in some or all of the pulleys 312, such that the pulleys 312 can align and guide the strip belt 130 around the pulley system 310, as described in further detail below.

FIG. 5 illustrates a bottom cross-sectional view of one of the strip belts 130. As shown, the strip belt 130 can comprise a belt body 520 and a belt guide 530. The belt body 520 can define the outer belt surface 432 and the inner belt surface 434 of the strip belt 130. In example aspects, the outer belt surface 432 and the inner belt surface 434 can be substantially planar and parallel to one another. The belt guide 530 can extend outward from the inner belt surface 434 about centrally between a first belt side 510 of the strip belt 130 and an opposite second belt side 512 of the strip belt 130. In example aspects, the belt guide 530 can extend longitudinally about a circumference of the strip belt 130. In some aspects, the belt guide 530 can extend substantially about the circumference of the strip belt 130, and in other aspect, the belt guide 530 may extend only partially about the circumference of the strip belt 130. Some or all of the pulleys 312 (shown in FIG. 3) can define the guide groove 1110 (shown in FIG. 11), which can be an annular guide groove 1110 extending circumferentially about the pulley 312. The belt guide 530 of the strip belt 130 can engage each of the guide grooves 1110 to maintain the alignment of the strip belt 130 on the pulley system 310 (shown in FIG. 3).

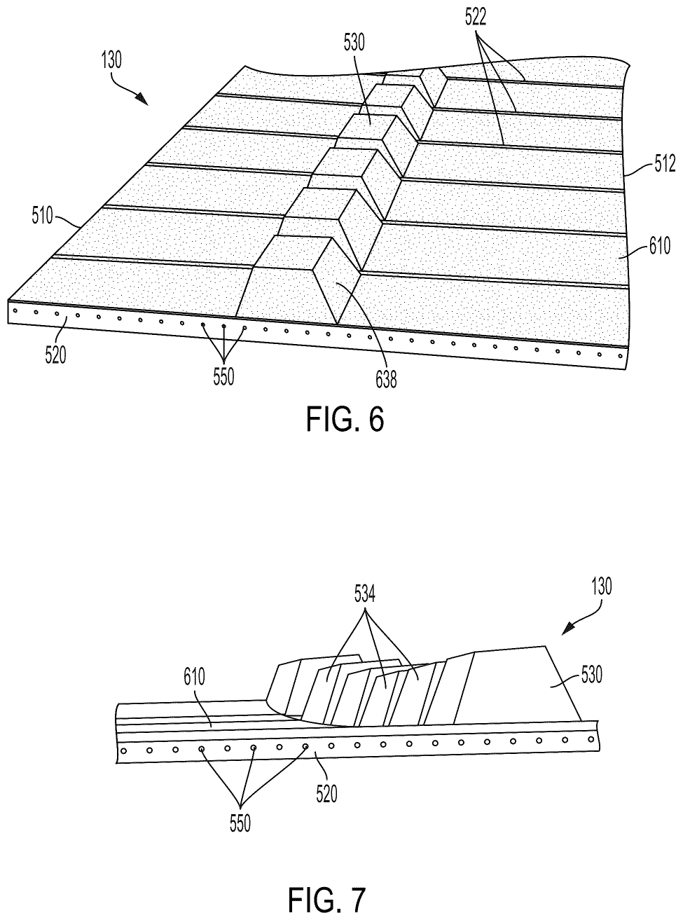

FIG. 5 illustrates the strip belt 130 with an overlay 610 (shown in FIG. 6) of the strip belt 130 removed for visibility of the inner belt surface 434 of the belt body 520. Example aspects of the belt body 520 and/or the belt guide 530 can comprise a flexible material, such as TPU (thermoplastic polyurethane), for example and without limitations. In other aspects, the belt body 520 and/or the belt guide 530 can comprise any other suitably flexible material, including but not limited to, various plastics, rubbers, and the like. In some aspects, the belt body 520 and/or the belt guide 530 can comprise a material having a substantially lower durometer and a substantially high coefficient of friction, as described in further detail below.

In the present aspect, the belt guide 530 can be monolithically formed (i.e., formed a singular component that constitutes a single material without joints or seams) with the belt body 520 during the manufacture of the strip belt 130, such as during extrusion or molding of the strip belt 130. The seamless, integral connection between the belt guide 530 and the belt body 520 can reduce the likelihood of failure at the connection. In other aspects, the belt guide 530 may be formed separately from the belt body 520 and attached thereto. The belt guide 530 can be a V-guide 532 in the present aspect. In some aspects, as shown, the V-guide 532 can be segmented into a plurality of guide projections 534. The guide projections 534 can be substantially longitudinally aligned, as shown. A guide notch 546 can be defined between each adjacent pair of guide projections 534 to facilitate bending of the strip belt 130 around the pulley system 310 (shown in FIG. 3). Each of the guide notches 546 can be substantially V-shaped in the present aspect.

In example aspects, as shown, each of the guide projections 534 can substantially define a truncated rectangular pyramid shape (such as a truncated square pyramid in some aspects). Each guide projection 534 can define a first guide sidewall 536, a second guide sidewall 638 (shown in FIG. 6) opposite the first guide sidewall 536, a first guide end wall 540, a second guide end wall 1042 (shown in FIG. 10) opposite the first guide end wall 540, and a guide top wall 544 distal to the belt body 520. Each of the first and second guide sidewalls 536,638 and the first and second guide end walls 540,1042 can extend between the belt body 520 and the guide top wall 544. The truncated rectangular pyramid shape of each of the guide projections 534 can taper towards the guide top wall 544. As such, a cross-sectional area of each guide projection 534 at the inner belt surface 434 can be greater than a cross-sectional area of the guide projection 534 at the guide top wall 544. The guide projections 534 can vary in shape in other aspects. In some aspects, segmentation grooves 522 can be formed in the inner belt surface 434 between each of the guide projections 534. Each of the segmentation grooves 522 can extend substantially laterally across a width of the strip belt 130 in the present aspect. That is, each of the segmentation grooves 522 can extend substantially from the first belt side 510 of the strip belt 130 to the second belt side 512 of the strip belt 130, as shown.

According to example aspects, a plurality of longitudinal reinforcement cords 550 can be imbedded within and can extend circumferentially about the belt body 520. The plurality of reinforcement cords 550 can be laterally aligned with one another and spaced apart substantially across the width of the strip belt 130 (i.e., substantially from the first belt side 510 of the strip belt 130 to the second belt side 512 of the strip belt 130). In example aspects, each of the reinforcement cords 550 can be imbedded within the belt body 520 during manufacture of the belt body 520 (e.g., during extrusion or molding of the belt body 520). In some aspects, the reinforcement cords 550 can be disposed proximate to the inner belt surface 434, as shown. Additionally, in some aspects, portions of the reinforcement cords 550 may be exposed at the segmentation grooves 522 formed in the inner belt surface 434. In other aspects, the reinforcement cords 550 can be disposed closer to or further from the inner belt surface 434. Example aspects of the reinforcement cords 550 can comprise a strong, flexible material, such as an aramid material (e.g., Technora® or Kevlar®), for example and without limitation. In other aspects, the reinforcement cords 550 can comprise any other suitably strong and flexible material. The reinforcement cords 550 can strengthen the strip belt 130 to reduce stretching of the strip belt 130, which can extend the lifespan of the strip belt 130.

FIG. 6 illustrates the strip belt 130 with the overlay 610 applied over both the inner belt surface 434 (shown in FIG. 5) of the belt body 520 and the belt guide 530. The overlay 610 can comprise a flexible material having a substantially low coefficient of friction, as compared to the coefficient of friction of the belt body 520 and the belt guide 530. For example and without limitation, the overlay 610 can comprise a nylon material in some aspects. In other aspects, however, the overlay 610 can comprise any other material having a suitably low coefficient of friction.

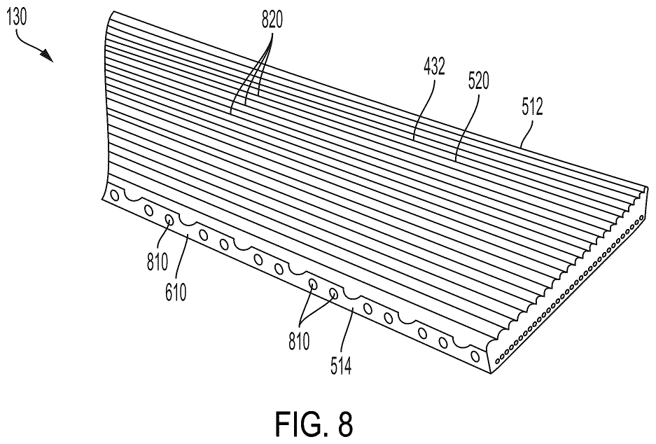

In some aspects, the overlay 610 can be configured to extend laterally at least substantially across the width of the strip belt 130 (i.e., at least substantially from the first belt side 510 to the second belt side 512), as shown, and can further extend longitudinally at least substantially about the circumference of the strip belt 130. The overlay 610 can thereby at least substantially cover both the inner belt surface 434 of the belt body 520 and the belt guide 530. That is, in some aspects, the overlay 610 can either substantially or fully cover both the inner belt surface 434 and the belt guide 530 extending therefrom. In some aspects, the overlay 610 can at least substantially cover the portions of inner belt surface 434 and the belt guide 530 that contact other components of the conveyor system 100 (shown in FIG. 1) to allow the strip belt 130 to slide across those components with minimal friction. For example, the overlay 610 may at least substantially cover the portions of the inner belt surface 434 and the belt guide 530 that contact the various pulleys 312 (shown in FIG. 3) of the pulley system 310 (shown in FIG. 3). The overlay 610 can be affixed to the strip belt 130 by any suitable fastener or fastening technique, including but not limited to, welding and adhesives. For example, in the present aspect, the overlay 610 can be affixed to the strip belt 130 by welding at various welding points 810 (shown in FIG. 8) along the first belt side 510 and the second belt side 512. The welding points 810 are shown for illustrative purposes only, and may not be as prominent or at all visible in other aspects. In example aspects, the overlay 610 can be affixed to the strip belt 130 after the molding or extrusion of the belt body 520 and the belt guide 530. The overlay 610 can be configured to stretch over the belt guide 530 during the application of the overlay 610 to the strip belt 130.

Covering the inner belt surface 434 and the belt guide 530 with the low-friction overlay 610 can reduce friction between the strip belt 130 and various components of the merge conveyor 120 (shown in FIG. 1) that contact the strip belt 130, such as the pulleys 312. Thus, less torque can be required to drive the strip belt 130. Additionally, the low-friction overlay 610 can also reduce wear on the strip belt 130, can strengthen the strip belt 130 (which can be particularly beneficial at weakened areas, such as where the segmentation grooves 522 are formed), and can protect any of the reinforcement cords 550 that may be exposed at the segmentation grooves 522 or elsewhere along the inner belt surface 434.

FIG. 7 illustrates another bottom cross-sectional view of the strip belt 130 showing example spacing of the reinforcement cords 550 laterally across the strip belt 130. In some aspects, the strip belt 130 can define a width of between about 30-80 mm. In some aspects, the strip belt 130 can define a width of between about 40-75 mm. In some aspects, the strip belt 130 can define a width of about 70 mm. In some aspects, a strip belt 130 having a width of about 70 mm can comprise between about 20-80 of the reinforcement cords 550. In some aspects, a strip belt 130 having a width of about 70 mm can comprise between about 25-50 of the reinforcement cords 550. In some aspects, a strip belt 130 having a width of about 70 mm can comprise about 30 of the reinforcement cords 550. In some aspects, each of the reinforcement cords 550 can be spaced from adjacent reinforcement cords 550 by between about 0.5 mm-3 mm. In some aspects, each of the reinforcement cords 550 can be spaced from adjacent reinforcement cords 550 by between about 2 mm-2.5 mm.

FIG. 8 illustrates a top cross-sectional view of the strip belt 130 showing the outer belt surface 432 of the strip belt 130. In some aspects, the outer belt surface 432 of the strip belt 130 can be textured to improve the grip of the strip belt 130 on the items 150 (shown in FIG. 1) being conveyed thereon. For example, the strip belt 130 can comprises one or more gripping features 820 formed in or on the outer belt surface 432, which in the present aspect can be a plurality of longitudinal gripping grooves 820. Each of the gripping grooves 820 can extend circumferentially about the strip belt 130. The gripping grooves 820 can also have the added benefit of allowing debris (e.g., dust, dirt, etc.) to fall into the gripping grooves 820, thus preventing the debris from interfering with the conveyance of items 150 along the strip belt 130. In some aspects, the longitudinal gripping grooves 820 can be formed in the belt body 520. In other aspects, the longitudinal gripping grooves 820 can be formed in a belt cover that can then be monolithically molded with or otherwise attached to the belt body 520 of the strip belt 130. In such aspects, the belt cover can define the outer belt surface 432 of the strip belt 130.

Moreover, in example aspects, the material of the strip belt 130 (such as thermoplastic polyurethane, for example and without limitation) can define a low durometer and can have a high coefficient of friction, which can further improve the grip of the outer belt surface 432 on the items 150 thereon. For example, in some aspects, the durometer of the strip belt 130 (e.g., the belt body 520 and the belt guide 530, shown in FIG. 5) can be between about 60-80. In some aspects, the durometer of the strip belt 130 can be between about 65-75. In some aspects, the durometer of the strip belt 130 can be about 70. Additionally, in aspects wherein the gripping grooves 820 are formed in the belt cover instead of the belt body 520, the belt cover may or may not comprise the same material as the belt body 520. In some aspects, the belt cover can comprise a material having a lower durometer than the material of the belt body 520 or a durometer about equal to or greater than the material of the belt body 520. Furthermore, in other aspects, the outer belt surface 432 or the groove cover can be alternatively textured. For example and without limitation, the outer belt surface 432 or the groove cover can define a rough or bumpy texture in some aspects.

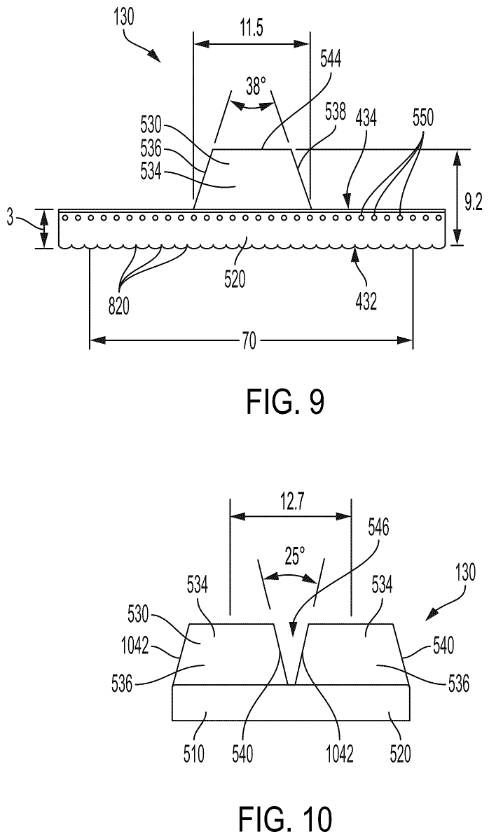

FIGS. 9 and 10 illustrate additional example dimensions of the strip belt 130, wherein the strip belt 130 defines a width of about 70 mm. The dimensions disclosed herein are merely exemplary and should not be construed as limiting. Referring to FIG. 9, according to example aspects, a thickness of the belt body 520 can be between about 2 mm-4 mm. In some aspects, the thickness of the belt body 520 can be between about 2.5 mm-3.5 mm. In some aspects, the thickness of the belt body 520 can be about 3 mm. Moreover, in example aspects, an overall thickness of the strip belt 130, including the belt body 520 and the belt guide 530, can be between about 7 mm-11 mm. In example aspects, the overall thickness of the strip belt 130 can be between about 8 mm-10 mm. In some aspects, the overall thickness of the strip belt 130 can be about 9.2 mm. Furthermore, in example aspects, an angle of between about 30°-50° can be defined between the opposing first and second guide sidewalls 536,638 of each guide projection 534. In some aspects, an angle of between about 35°-45° can be defined between the opposing first and second guide sidewalls 536,638. In some aspects, an angle of about 38° can be defined between the opposing first and second guide sidewalls 536,638. Additionally, in some aspects, a width of the belt guide 530 can be between about 10 mm-13 mm. In some aspects, a width of the belt guide 530 can be between about 11 mm-12 mm. In some aspects, a width of the belt guide 530 can be about 11.5 mm.

FIG. 10 illustrates a side view showing a short section of the strip belt 130. According to example aspects, the V-shaped guide notch 546 between adjacent guide projections 534 can define an angle of between about 15°-35°. Put another way, an angle of about 15°-35° can be defined between the first guide end wall 540 of each guide projection 534 and the confronting second guide end wall 1042 of each adjacent guide projection 534. In some aspects, the guide notch 546 can define an angle of between about 20°-30°. In some aspects, the guide notch 546 can define an angle of about 25°. Additionally, in example aspects, a length of each guide projection 534 can be between about 11 mm-15 mm. In some aspects, a length of each guide projection 534 can be between about 12 mm-14 mm. In some aspects, a length of each guide projection 534 can be about 12.7 mm.

FIG. 11 illustrates a cross-sectional view of the strip belt 130 engaged with one of the pulleys 312 of the pulley system 310. For example, the pulley 312 can be the tail pulley 312b. The pulley 312 can define the guide groove 1110. The guide groove 1110 can substantially annular in the present aspect and can extend centrally around a circumference of the pulley 312. The strip belt 130 can define the belt body 520 and the belt guide 530 extending from the belt body 520. The overlay 610 (shown in FIG. 6) can cover the inner belt surface 434 (shown in FIG. 4) of the strip belt 130, and the pulley 312 can confront and contact the overlay 610 at either side of the belt guide 530. The low-friction overlay 610 can allow the strip belt 130 to slide across the pulley 312 with minimal friction. Furthermore, the guide groove 1110 of the pulley 312 can receive the belt guide 530 of the strip belt 130 to align and guide the strip belt 130 about the pulley system 310. The overlay 610 can further cover the belt guide 530 to allow the belt guide 530 to slide within the guide groove 1110 with minimal friction.

According to example aspects, the various features of the strip belts 130 described herein can be applied to any other suitable conveyor belt for conveying items 150 (shown in FIG. 1) from a first location to a second location. Such features can include, but are not limited to, the belt guide 530 formed monolithically with the belt body 520, the longitudinal reinforcement cords 550 molded with the belt body 520, the endless splicing of the opposing free ends of the strip belt 130 to form the endless strip belt 430, and the low-friction overlay 610 applied to the inner belt surface 434 and the belt guide 530 of the strip belt 130. For example, in another aspect, some or all of the features of the strip belts 130 could also or alternatively be applied to the primary conveyor belt 112 (shown in FIG. 1) or any other suitable conveyor belt.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A conveyor belt comprising:
a belt body defining an outer belt surface and an inner belt surface opposite the outer belt surface;
a belt guide extending outward from the inner belt surface of the belt body and monolithically formed with the belt body; and
a plurality of longitudinal reinforcement cords imbedded within the belt body.

2. The conveyor belt of claim 1, wherein:
the conveyor belt defines a first belt side and a second belt side opposite the first belt side;
a width of the conveyor belt is defined between the first belt side and the second belt side; and
the plurality of longitudinal reinforcement cords are laterally spaced substantially across the width of the conveyor belt.

3. The conveyor belt of claim 2, wherein the plurality of longitudinal reinforcement cords are disposed proximate to the inner belt surface.

4. The conveyor belt of claim 2, further comprising a low-friction overlay applied to the conveyor belt and at least partially covering the inner belt surface and the belt guide.

5. The conveyor belt of claim 4, wherein the low-friction overlay extends substantially across the width of the conveyor belt to substantially cover the inner belt surface and the belt guide.

6. The conveyor belt of claim 1, wherein:
the conveyor belt defines a first belt side and a second belt side opposite the first belt side;
the belt guide extends outward from the inner belt surface about centrally between the first belt side and the second belt side; and
the belt guide extends longitudinally about a circumference of the conveyor belt.

7. The conveyor belt of claim 6, wherein the belt guide defines a plurality of guide projections, the plurality of guide projections are longitudinally aligned, and a substantially V-shaped guide notch is defined between each adjacent pair of the guide projections.

8. The conveyor belt of claim 7, wherein:
each of the guide projections defines a truncated rectangular pyramid shape;
each of the guide projections define a guide top wall distal to the inner belt surface of the belt body; and
the truncated rectangular pyramid shape of each of the guide projections taper towards the guide top wall.

9. The conveyor belt of claim 1, wherein the conveyor belt defines opposing free ends, and wherein the opposing free ends of the conveyor belt are coupled together by an endless splice to form an endless conveyor belt.

10. The conveyor belt of claim 1, wherein the outer belt surface defines a gripping feature, the gripping feature is a plurality of gripping grooves, and the plurality of gripping grooves extend longitudinally about a circumference of the conveyor belt.

11. A conveyor system comprising:
a pulley system comprising a rotating pulley, the rotating pulley defining an annular guide groove extending about a circumference of the rotating pulley; and
a conveyor belt configured to slide along the rotating pulley, the conveyor belt comprising a belt body and a belt guide, the belt body defining an outer belt surface and an inner belt surface opposite the outer belt surface, the belt guide extending outward from the inner belt surface of the belt body and monolithically formed with the belt body;
wherein the belt guide of the conveyor belt engages the annular guide groove of the rotating pulley to align the conveyor belt on the rotating pulley and to guide the conveyor belt about the pulley system.

12. The conveyor system of claim 11, wherein:
the conveyor belt defines a first belt side and a second belt side opposite the first belt side;
the belt guide extends outward from the inner belt surface about centrally between the first belt side and the second belt side; and
the belt guide extends longitudinally about a circumference of the conveyor belt.

13. The conveyor system of claim 12, wherein the belt guide defines a plurality of guide projections, the plurality of guide projections are longitudinally aligned, and a substantially V-shaped guide notch is defined between each adjacent pair of the guide projections.

14. The conveyor system of claim 13, wherein:
each of the guide projections defines a truncated rectangular pyramid shape;
each of the guide projections define a guide top wall distal to the inner belt surface of the belt body; and
the truncated rectangular pyramid shape of each of the guide projections taper towards the guide top wall.

15. The conveyor system of claim 12, wherein:
a plurality of longitudinal reinforcement cords are imbedded within the belt body;
a width of the conveyor belt is defined between the first belt side and the second belt side; and
the plurality of longitudinal reinforcement cords are laterally spaced substantially across the width of the conveyor belt.

16. The conveyor system of claim 11, further comprising a low-friction overlay applied to the conveyor belt and substantially covering portions of the inner belt surface and the belt guide that contact the rotating pulley.

17. The conveyor system of claim 11, wherein the conveyor belt defines opposing free ends, and wherein the opposing free ends of the conveyor belt are coupled together by an endless splice to form an endless conveyor belt.

18. The conveyor system of claim 11, wherein the outer belt surface defines a gripping feature, the gripping feature is a plurality of gripping grooves, and the plurality of gripping grooves extend longitudinally about a circumference of the conveyor belt.

19. The conveyor system of claim 11, wherein:
the conveyor system is a merge conveyor system;
the conveyor belt is one of a plurality of strip conveyor belts; and
the plurality of strip conveyor belts are arranged laterally side by side and parallel to one another.

20. The conveyor system of claim 19, wherein:
the merge conveyor system defines a first merge conveyor end and a second merge conveyor end;
each of the strip conveyor belts defines a proximal belt end and a distal belt end opposite the proximal belt end;
the proximal belt end of each of the strip conveyor belts is disposed adjacent to the second merge conveyor end; and
the proximal belt end of each of the strip conveyor belts is longitudinally offset from the proximal belt end of each adjacent strip conveyor belt.
